(19) United States
(12) Patent Application Publication
(10) Pub. No.: US 2020/0254655 A1
(43) Pub. Date: Aug. 13, 2020

(54) DECORATIVE COATING METHODS, SYSTEMS, AND DEVICES

(71) Applicant: ByDesign, LLC, Malibu, CA (US)

(72) Inventors: James Byford, Malibu, CA (US); Lorne Mash, Santa Monica, CA (US)

(21) Appl. No.: 16/783,004

(22) Filed: Feb. 5, 2020

Related U.S. Application Data
(60) Provisional application No. 62/802,960, filed on Feb. 8, 2019.

(51) Int. Cl. B29C 37/00; B29C 33/58; B29C 35/02; C08L 67/07; C08K 7/16; B29C 39/10; B29C 39/36

(52) U.S. Cl. CPC B29C 37/0032; B29C 33/58; B29C 35/02; C08L 67/07; B29K 2509/02; B29C 39/10; B29C 39/36; B29K 2909/08; B29K 2883/00; C08K 7/16

(57) ABSTRACT

A decorative coatings method, system, device, and composition, wherein the initial part may be the blending of several materials to create the face coat. The next step may be the application of this face coat into a mold. Then the backfilling of this mold with another blended material that is not usually associated with the face coat. The method ensures the adhesion of the backfill to the face coat. The specific mixtures allow the materials to bond and form a solid product when removed from the mold.

### CROSS-REFERENCE TO RELATED APPLICATIONS

This Application claims the benefit of U.S. Provisional Patent Application No. 62/802,960, filed on Feb. 8, 2019, titled “DECORATIVE COATING METHODS, SYSTEMS, AND DEVICES”, the contents of which is expressly incorporated herein by this reference as though set forth in their entirety.

### FIELD OF USE

The present disclosure relates generally to a method for adding a metal or concrete coating to interior and exterior design products. More specifically, the present disclosure relates to a process of using powdered metal or concrete to create an appearance of a metal or concrete surface on lighter-weight materials.

### BACKGROUND

The foundations of construction primarily focus on four aspects: weight, durability, aesthetic, and cost-effectiveness. While there are some materials that are both durable and aesthetically pleasing, like marble, they are often prohibitively heavy and expensive. Similarly, when something is both durable and cost-effective, like cinder blocks, it can be visually unappealing. Because there is a constant desire in construction to meet these four characteristics, builders will often use something cheap and durable as the base of a project and apply something aesthetically pleasing and cost effective to the outside. However, there are often limitations to this, as certain materials such as metal and concrete are quite heavy and, in the case of the former, can be expensive.

There is, thus, a need in the art for a method that provides the aesthetic appearance of metal or concrete without the associated drawbacks such as excessive weight, inflexibility, permanency, and cost.

### SUMMARY

To minimize the limitations in the cited references, and to minimize other limitations that will become apparent upon reading and understanding the present specification, the present specification discloses method for creating a material with the appearance of either metal or concrete.

In one embodiment, the device of the present disclosure simulates a metal surface. Preferably, the metal surface will mimic the appearance of one of several different metals by using powdered metals, including bronze, brass, tin, zinc, copper, aluminum, and the like, to create an outer coat or coating. The core of the material may be solid and may use either a ceramic or resin mixture to give it strength and durability. A material with the appearance of metal as well as rigidity will prove to be an effective replacement for decorations that would otherwise be more much, much more expensive if they were actually made from a solid metal. The process of the present disclosure also results in a product that is much more durable and aesthetically pleasing than if a metal plating process is used.

An embodiment of this the present disclosure is a method to make a material that mimics a metal's appearance and is made in a mold. This method comprises a fiberglass or tin silicone mold; a release agent; a metal power and resin mixture; a spray gun; a ceramic filler; a catalyst; a vacuum chamber; and a compressed air jet. Dimethyl ether may be applied to a fiberglass or silicone mold to aid in the release of the material from the mold. Using the spray gun, the metal powder and resin mixture may be sprayed onto the inside of the mold and allowed to cure. The catalyst may be added to the ceramic filler and the filler may be placed in a vacuum chamber to remove air. The Ceramic filler may then be added to the mold. The material may be allowed to cure and may then be removed from the mold with the assistance of a compressed air jet.

In another embodiment, the method makes a material with the appearance of concrete on the outside, but with a lighter inner core. Preferably, the outer surface of the material incorporates actual cement. The core of the material may not be made with concrete, and instead may incorporate materials such as ceramic or urethane in order to make the final product substantially lighter in weight than one made of solid concrete.

An embodiment of this the present disclosure is a method to make a material that mimics concrete's appearance and is made in a mold. This method comprises of fiberglass or tin silicone mold; a release agent; a powdered cement, powdered quartz, powdered sand, and powdered polymer mixture; a spray gun; a paint brush; a ceramic filler; a catalyst; a vacuum chamber; a concrete sealer; and a compressed air jet. Dimethyl ether may be applied to a fiberglass or silicone mold to aid in the release of the material from the mold. Using the spray gun, the powdered cement, powdered quartz, powdered sand, and powdered polymer mixture may be sprayed onto the inside of the mold and allowed to cure. Using a brush, the mixture may be spread along the inside of the mold in order to eliminate holes and air pockets. The catalyst may be added to the ceramic filler and the filler may be placed in a vacuum chamber to remove air. The ceramic filler may then be added to the mold. The material may be allowed to cure and may then be removed from the mold with the assistance of a compressed air jet.

The material coatings of the present disclosure may be sprayed into a closed cavity mold and the mold may then be backfilled or reinforced with other blended mold fillers to obtain the required lightweight but highly durable product.

The materials and methods of the present disclosure may provide a more luxurious finish to standard products. The present disclosure achieves this without the excessive weight of making the entire product from solid concrete or metal.

The initial step may be the blending of several materials to create the face coat. The next step may be the application of this face coat into a mold. Then the backfilling of this mold with another blended material that is not usually associated with the face coat. The present disclosure allows for the adhesion of the backfill to the face coat. The specific mixtures allow the two materials to bond and form a solid product when removed from the mold.

An embodiment of the method of the present disclosure may comprise incorporating a white or colored solid surface coat to the created products with a sprayed concrete outer shell. The outside of the already molded product is spray coated with a white or colored modified concrete coating, allowed to dry, and then finished by sanding and sealing.

One embodiment may be a method of creating a product with a decorative coating comprising the steps: providing a mold; mixing a decorative coating material with a substrate material to create a face coat mixture; spraying the face coat mixture onto the mold; preparing a backfill mixture, wherein the backfill mixture comprises at least one of a catalyst, a ceramic microsphere filler, and a resin; pouring the backfill mixture onto the face coat mixture on the mold; curing the backfill mixture, such that the cured face coat mixture and the cured backfill mixture bind to each other to create a molded product; and de-molding the molded product. The method may further comprise applying a releasing agent to the mold and curing the sprayed face coat mixture. The mold may be selected from the group of molds consisting of one or more of: fiberglass; tin cured silicone; and combinations thereof. The releasing agent may be The method of claim 2, wherein the releasing agent is dimethyl ether. The face coat mixture may comprise: a metal powder and a face coat resin. The metal powder may be at least 99.5% pure grade and −300 to −350 mesh size. The face coat resin may be selected from the group of resins consisting of one or more of: styrene thinned polyester resin, vinyl ester resin, and combinations thereof. The metal powder may be selected from the group of metal powders consisting of one or more of: bronze, zinc, tin, brass, aluminum, metal carbides, chromium, cobalt, hafnium, iron, molybdenum, nickel, copper, niobium, platinum, rhenium, silicon, silver, tungsten, tantalum, vanadium, alloys of the same, and combinations thereof. Preferably, the metal powder may be, by weight, approximately 2.5 times greater than the face coat resin. The method may further comprise mixing the face coat mixture with a face coat catalyst before spraying the face coat mixture onto the mold. The face coat catalyst is methyl ethyl ketone peroxide and is, by weight, approximately 2% of the face coat resin. The backfill mixture may comprise: an unsaturated polyester resin and an aluminum powder at approximately 80-120%, by weight, of the unsaturated polyester resin. The backfill mixture may further comprises a pigment of color at approximately 0.5-3.0%, by weight, of the unsaturated polyester resin. The method may further comprise mixing the backfill mixture with a backfill mixture catalyst, such that a catalyzed backfill mixture is created. The backfill mixture may further comprise the engineered ceramic microsphere filler at approximately 80-120%, by weight, of the unsaturated polyester resin. The backfill mixture catalyst may be methyl ethyl ketone peroxide and is added at approximately 2%, by weight of the backfill mixture. The method may further comprise degassing the catalyzed backfill mixture in a vacuum chamber before pouring the backfill mixture onto the face coat mixture on the mold. The method may further comprise polishing the molded product after it is de-molded. In another embodiment, the face coat mixture may comprise: white type 1 Portland cement; quartz; calcium carbonate; powdered polymer; sand; fiberglass mesh; and water. The face coat mixture may further comprise a pigment of color, which is approximately 0.5-3.0%, by weight, of the face coat mixture. The white type 1 Portland cement may be approximately 20-40%, by weight, of the face coat mixture; wherein the quartz may be approximately 5-25%, by weight, of the face coat mixture; wherein the calcium carbonate may be approximately 10-15%, by weight, of the face coat mixture; wherein the powdered polymer may be approximately 10-15%, by weight, of the face coat mixture; wherein the sand may have a mesh size in the range of 18 to 50 and may be approximately 30-35%, by weight, of the face coat mixture; and wherein the fiberglass mesh may be a 3 mm short strand alkali resistant fiberglass mesh and is approximately 0.5-1.0%, by weight, of the face coat mixture. The method may further comprise brushing out the face coat mixture after it is sprayed onto the mold and before it is cured. The backfill mixture may comprise in approximately equal parts: a urethane and the engineered ceramic microsphere filler. The method may further comprise degassing the backfill mixture in a vacuum chamber before pouring the backfill mixture onto the face coat mixture on the mold. The method may further comprise finishing and sealing the molded product after it is de-molded. The backfill mixture may be a lightweight backing mixture that comprises: the resin and the catalyst. The catalyst may be methyl ethyl ketone peroxide and may be approximately 1.0%-3.0%, by weight, of the resin. The resin may be selected from the group of resins consisting of one or more of: styrene thinned polyester resin, vinyl ester resin, and combinations thereof. The method may further comprise: spraying the light weight backing mixture onto the cured face coat mixture; curing the lightweight backing mixture; and reinforcing an exposed surface of the lightweight backing mixture with a fiberglass spray lay-up process.

Other features and advantages will become apparent to those skilled in the art from the following detailed description and its accompanying drawings.

### BRIEF DESCRIPTION OF THE DRAWINGS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

FIG. 1 is a photograph of a metal coated bathtub created by one embodiment of the present disclosure.

FIG. 2 is a photograph of a cement coated bathtub created by another embodiment of the present disclosure.

FIG. 3 is a photograph of a colored cement coated bathtub created by another embodiment of the present disclosure.

FIG. 4 is a photograph of a cement coated bathtub created by another embodiment of the present disclosure.

FIG. 5 is a photograph of a cement coated wall panel created by another embodiment of the present disclosure.

FIG. 6 is a photograph of a cement coated wall panel created by another embodiment of the present disclosure.

FIG. 7 is a photograph of a cement coated wall panel created by another embodiment of the present disclosure.

FIG. 8 is a photograph of a cement coated wall panel created by another embodiment of the present disclosure.

FIG. 9 is a photograph of a metal coated wall panel created by another embodiment of the present disclosure.

FIG. 10 is a photograph of a metal coated wall panel created by another embodiment of the present disclosure.

FIG. 11 is a photograph of a metal coated wall panel created by another embodiment of the present disclosure.

FIG. 12 is a photograph of a flexible urethane metal sheet created by another embodiment of the present disclosure.

FIG. 13 is a photograph of a flexible urethane metal sheet created by another embodiment of the present disclosure.

FIG. 14 is a photograph of a concrete decorative coating being sprayed onto a mold for creating a bathtub.

FIG. 15 is a photograph of a metal decorative coating being sprayed onto a mold for creating a panel.

FIG. 16 is a photograph of the metal decoratively coated panel being sprayed polished.

### DETAILED DESCRIPTION OF THE EMBODIMENTS

In the following detailed description of various embodiments, numerous specific details are set forth in order to provide a thorough understanding of various aspects of the embodiments. However, the embodiments may be practiced without some or all of these specific details. In other instances, well-known procedures and/or components have not been described in detail so as not to unnecessarily obscure aspects of the embodiments.

While some embodiments are disclosed here, other embodiments will become obvious to those skilled in the art as a result of the following detailed description. These embodiments are capable of modifications of various obvious aspects, all without departing from the spirit and scope of protection. The Figures, and their detailed descriptions, are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, group of items, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, group of items, or result. In another example, substantially all of a group of items, may include all of the items of that group, or at least all of the items of that group that re generally within the normal parameters for the items. To the extent that the group of items might include members that far exceed the normal parameters, this abnormal item might not be expected to be part of substantially all the group of items.

As used herein, the terms “approximately” and “about” generally refer to a deviance of within 5% of the indicated number or range of numbers. In one embodiment, the term “approximately” and “about”, may refer to a deviance of between 0.0001-10% from the indicated number or range of numbers.

As used herein, the term “decorative coating material” refers to cement or metal powder that may be mixed with a resin, urethane, and/or filler to create a decoratively coated product, panel, or fabric.

As used herein the term “substrate material” refers to a resin, urethane, and/or polymer mixture that is configured to be combined with a decorative coating material.

One embodiment of the present disclosure may be a method that creates a product with a decorative coating using a decorative coating material, comprising the steps:
Providing a mold;
Applying a releasing agent to a clean surface of the mold;
Mixing a decorative coating material with a substrate material to create a face coat mixture;
Spraying the face coat mixture onto the mold;
Curing;
Backfilling the mold with a backfill mixture that may comprise ceramic microsphere fillers and/or a catalyst;
   The ceramic microsphere fillers do not need to be added to the backfill mixture, unless the intention and need is to make the product weight less than it would without the microspheres.
Curing;
Unmolding; and
Finish and/or treating the decorative coating surface.

One embodiment of the present disclosure may be a method that creates a metal outer shell and a solid, but lightweight, inner core, comprising the steps:
Providing a mold, preferably made out of fiberglass or tin silicone (also called tin cured silicone);
   Although fiberglass or tin cured silicone are preferred for the mold, other types of materials may be used for the mold, including, but not limited to: Regular silicone, wood framed, metal framed, injected plastic.
   The mold may be a single piece or may have multiple parts.
Applying a dimethyl ether release agent to a clean surface of the fiberglass or tin silicone mold surface in preparation for a face coat.
   Other releasing agents can be used, including, but not limited to: Wax, oil, soap
Mixing a metal and resin mixture, comprising:
   a 99.9% pure grade (preferably (and at least 75%, −250 to −400 mesh metal powder, and
   either styrene thinned polyester resin or vinyl ester resin.
   Any metal or metal composite powder may be used, including, but not limited to bronze, zinc, tin, brass, aluminum, metal carbides, chromium, cobalt, hafnium, iron, molybdenum, nickel, copper, niobium, platinum, rhenium, silicon, silver, tungsten, tantalum, vanadium, and alloys of the same. The metal powder may be made from direct reduction or atomization (gas, liquid, or centrifugation).
   Although styrene thinned polyester resin and vinyl ester resin are preferred, other resins may be used, including but not limited to: Polyester, Vinyl Ester and Urethane
   Preferably the metal powder is, by weight, between 2 and 3 times greater than the resin that is added.
Adding, preferably, a catalyst, such as methyl ethyl ketone peroxide to the metal and resin mixture.
   Preferably the catalyst is added at approximately 2% of the resin weight.
Loading the metal and resin mixture into a spray gun;
   The spay gun may preferably use compressed air and be gravity fed. Other conventional paint spray methods may be used.
Spaying the surface of the mold with the metal and resin mixture using the spray gun.
   In one embodiment, the spray gun nozzle size may be in the range of 1 mm-3 mm for the metal.
Curing the mold for an appropriate time.
   The metal and resin mixture may be allowed to cure for between 30 minutes and 2 hours depending on ambient temperature before the mold backfill is poured into the mold.
Mixing a mold backfill, which may comprise:
   unsaturated polyester resin
   aluminum powder at 80-120% resin weight
   optionally, engineered ceramic microsphere filler at 80-120% of resin weight
      typically, the microspheres, which may be made from other materials, including plastic or glass, are hollow spheres that have the appearance of fine powder and may ranging from 10 to 400 μm in diameter.
   optionally, pigment of color at 0.5%-3% of the unsaturated polyester resin weight
      the pigment may be any color, including white, and may be various colored iron oxide pigments
      The addition of a pigment of color may allow the user to create products of various colors and attractiveness.
   Optionally, cobalt may be added in small amounts. Cobalt is typically added because it causes an exothermic reaction during the cure which speeds up the cure time for the resin.
   preferably, the mold backfill is solid, strong, and light weight, so that the product is strong but lighter than it would be if a sold metal product were to be made.
Catalyzing the mold backfill by adding methyl ethyl ketone peroxide to the mold back fill
   Preferably the catalyst is added at approximately 1%-3% of the backfill weight.
Placing the catalyzed backfill mixture in a vacuum chamber to remove air from the mixture.
Pouring the degassed and catalyzed backfill mixture into the mold.
Curing the molded product for an appropriate amount of time. The molded product may be allowed to cure for approximately 30-60 minutes before the product is demolded.
Demolding the molded product, preferably using a compressed air jet.
   The demolded product may be allowed to cure for 4 hours or more before finishing the product.
Finishing the molded product, preferably by sanding and polishing.
   In various embodiments, the sanding and polishing may be accomplished by using sandpaper, wire wool, hand sanding, orbital sanding machines, and polishing machines. The finishing process may be similar to auto body sanding and polishing

Another embodiment may be a method that creates a molded product that has a cement outer shell and a lightweight inner core, comprising the steps:
Providing a fiberglass or tin cured silicone mold.
Applying a dimethyl ether release agent to a clean surface of mold surface in preparation for a face coat.
Mixing a cement face coat, which may comprise:
   white type 1 Portland cement at approximately 20%-40% of total dry weight
   quartz at approximately 5%-25% of total dry weight.
   calcium carbonate at approx. 10%-15% of total dry weight
      preferably, the calcium carbonate acts as an acid neutralizing agent
   powdered polymer at approximately 10%-15% of total dry weight
      preferably the powdered polymer is a latex polymer but may also be various latex polymer substitutes.
   sand, preferably with a mesh size of 30 at 30%-35% of total dry weight
      the mesh size of the sand may preferably be in the range of 20 to 60
   optionally, a pigment (white or any color), which is preferably an iron oxide pigment at 0.5%-3% of total dry weight
   3 mm short strand alkali resistant fiberglass mesh at 0.5%-1% of total dry weight
   Water. The amount of water added varies but preferably is added until the consistency of material is fluid enough to spray through the gun but thick enough to adhere to mold surface without running off the mold.
Loading the cement face coat into a spray gun.
Spraying the surface of the mold with the cement face coat using the spray gun.
In one embodiment, the spray gun is a cement spray gun and hopper for the cement face coat.
Brushing out, using, preferably, a synthetic paint brush, the cement face coat to eliminate holes, pin holes, and/or air pockets.
Curing the cement face coat in the mold for an appropriate amount of time.
   Preferably, the cement face coat is cured overnight.
Mixing a lightweight mold backfill mixture, using a slow mixing speed, wherein the mold backfill mixture which may comprise, in approximately equal parts:
   urethane, preferably a fast curing, low thermoforming urethane.
   engineered ceramic microsphere filler
      If weight is not an issue, then the microsphere filler may be added in less than an equal amount or not added at all.
Placing the mold backfill mixture in a vacuum chamber to remove air from the mixture.
Pouring the degassed backfill mixture into the mold.
Curing for an appropriate amount of time, preferably 20 minutes to 2 hours. More preferably for 45 minutes.
Demolding the molded product, preferably using a compressed air jet.
Curing further for several more hours.
Processing the outer surface of the molded product, which may include sanding, buffing, polishing.
Sealing, optionally and when appropriate, the outer surface of the molded product, preferably using a penetrating concrete sealer.

Another embodiment may be a method that creates a molded product with a cement outer shell and a lightweight inner core, comprising the steps:
Providing a fiberglass or tin cured silicone mold.
Applying a dimethyl ether release agent to a clean surface of mold surface in preparation for a face coat.
Mixing a cement face coat, which may comprise:
   white type 1 Portland cement at approximately 20%-40% of total dry weight
   quartz at approximately 5%-25% of total dry weight
   calcium carbonate at approx. 10%-15% of total dry weight
      preferably, the calcium carbonate acts as an acid neutralizing agent
   powdered polymer at approximately 10%-15% of total dry weight
   sand, preferably with a mesh size of 30 at 30%-35% of total dry weight
   optionally, a pigment (white or any color), which is preferably an iron oxide pigment at 0.5%-3% of total dry weight
   3 mm short strand alkali resistant fiberglass mesh at 0.5%-1% of total dry weight
   Water in an amount to allow the solution to be sprayed from a spray gun, but not so wet that the solution will not adhere to the mold surface.
Loading the cement face coat into a spray gun.
Spraying the surface of the mold with the cement face coat using the spray gun.
Brushing out, using, preferably, a synthetic paint brush, the cement face coat to eliminate holes, pin holes, and/or air pockets.
Curing the cement face coat in the mold for an appropriate amount of time.
Mixing a lightweight backing mixture, comprising:
   either styrene thinned polyester resin or vinyl ester resin; and
   a catalyst, which may preferably be methyl ethyl ketone peroxide, which is added, preferably at 1.0-3.0%, by weight, of the resin;
Loading the backing mixture into a modified spray gun
   The spray gun may have a 1.0 mm-2.00 mm nozzle, but this can vary.
Applying a flash coat of the backing mixture to the exposed back side surface of the cured cement face coat using the spray gun.
Curing the flash coat of the backing mixture for an appropriate time, which may be 30-120 minutes
Reinforcing the exposed surface of the backing mixture with a standard fiberglass spray lay-up process.
   The fiberglass spray lay-up process generally comprises spaying polyester resin along with short strands of glass (called fiberglass) out of a pneumatic gun. The spraying is done a number of times to increase thicknesses and strength. The more spaying that is done, the stronger and thicker the fiberglass layer is.
The fiberglass layers are cured and then the molded product de-molded.

Another embodiment may be a method of creating a metal impregnated rigid panel comprising the steps:
Providing a mold, preferably made out of fiberglass or tin silicone (also called tin cured silicone);
Applying a dimethyl ether release agent to a clean surface of the fiberglass or tin silicone mold surface in preparation for a metal impregnated rigid panel.
Mixing a metal and urethane mixture, in approximately equal parts (as preferred), comprising:
   a −300 to −350 mesh metal powder, 99.9% pure grade, as preferred and at least 95.0;
   urethane, preferably a fast curing, low thermoforming urethane
      Any metal or metal composite powder may be used, including, but not limited to bronze, zinc, tin, brass, aluminum, metal carbides, chromium, cobalt, hafnium, iron, molybdenum, nickel, copper, niobium, platinum, rhenium, silicon, silver, tungsten, tantalum, vanadium, and alloys of the same. The metal powder may be made from direct reduction or atomization (gas, liquid, or centrifugation). Mixtures of different metals may be used.
Mixing a ceramic microsphere and urethane mixture, in approximately equal parts (as preferred), comprising:
   urethane, preferably a fast curing, low thermoforming urethane.
   engineered ceramic microsphere filler
      If weight is not an issue, then the microsphere filler may be added in less than an equal amount or not added at all.
Mixing the metal and urethane mixture with the ceramic microsphere and urethane mixture, in equal parts.
   Preferably, this final mixture is two parts urethane, 1 part metal, and 1 part ceramic microsphere filler.
Pouring the urethane, metal, and ceramic microsphere mixture into the mold.
Curing the molded urethane, metal, and ceramic microsphere mixture for 20 minutes to four hours. Preferably, for approximately two hours.
De-molding the molded urethane, metal, and ceramic microsphere product.
Polishing the molded urethane, metal, and ceramic microsphere product.
The product may be used as a surface, which as a wall, panel.

Another embodiment may be a method of creating a flexible urethane metal sheet comprising the steps:
Providing a mold, preferably made out of fiberglass or tin silicone (also called tin cured silicone);
Applying a dimethyl ether release agent to a clean surface of the fiberglass or tin silicone mold surface in preparation for a metal impregnated rigid panel.
Mixing a metal and urethane mixture, approximately 1-2 part metal to 4 parts urethane, comprising:
   a −300 to −350 mesh metal powder, 99.9% pure grade, as preferred and at least 95.0;
   urethane, preferably a fast curing, low thermoforming urethane
      Any metal or metal composite powder may be used, including, but not limited to bronze, zinc, tin, brass, aluminum, metal carbides, chromium, cobalt, hafnium, iron, molybdenum, nickel, copper, niobium, platinum, rhenium, silicon, silver, tungsten, tantalum, vanadium, and alloys of the same. The metal powder may be made from direct reduction or atomization (gas, liquid, or centrifugation). One, two, or more metals may be mixed to form the metal powder.
Providing a second urethane mixture, comprising:
   urethane, preferably a fast curing, low thermoforming urethane.
Mixing the metal and urethane mixture with the second urethane mixture, in equal parts.
   Preferably, this final mixture is seven parts urethane to 1 part metal.
Pouring the urethane and metal mixture into the mold.
Curing the molded urethane and metal, mixture for 20 minutes to four hours. Preferably, for approximately two hours.
De-molding the molded urethane and metal product.
Polishing the molded urethane and metal product.

The drawings show illustrative embodiments of products created by the methods of the present disclosure, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

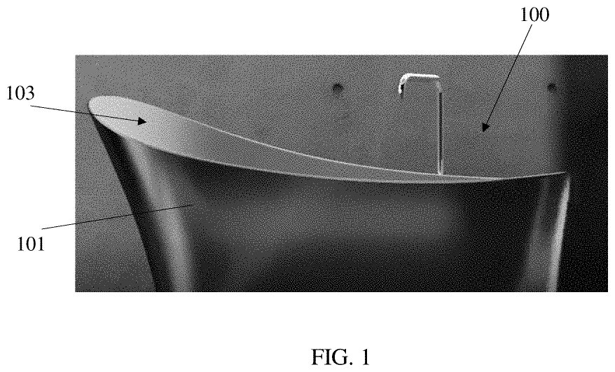

FIG. 1 is a photograph of a metal coated bathtub created by one embodiment of the present disclosure. FIG. 1 shows that bathtub 100 has been polished and now has a shiny metal outer surface 101 and solid, but lightweight, inner core 103. In some embodiments, the polished metal surface may be on the outside and inside of the bathtub, or other product, and the solid, but lightweight, inner core would not be visible and the bathtub would look like and feel as if it were made of solid metal. But it would be much less expensive than a solid metal product, but just as durable. Other products that may be made include, but are not limited to: sinks, furniture and works of art.

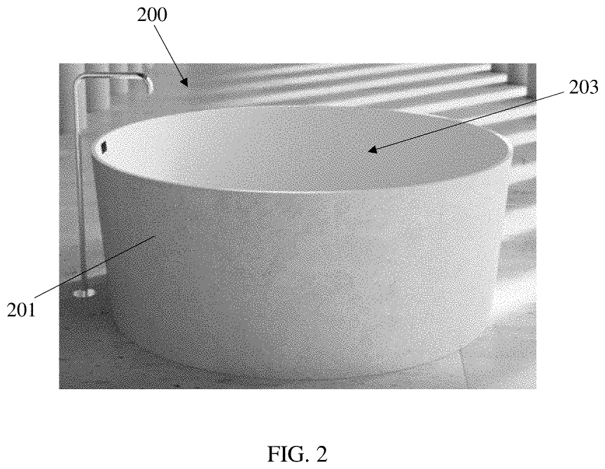

FIG. 2 is a photograph of a cement coated bathtub created by another embodiment of the present disclosure. FIG. 2 shows that bathtub 200 has decorative concrete outer surface 201 and solid, but lightweight, inner core 203. In some embodiments, the decorative concrete surface may be on the outside and inside of the bathtub, or other product, and the solid, but lightweight, inner core would not be visible and the bathtub would look like and feel as if it were made of solid concrete. But it would be much less expensive and much lighter in weight than a solid concrete product.

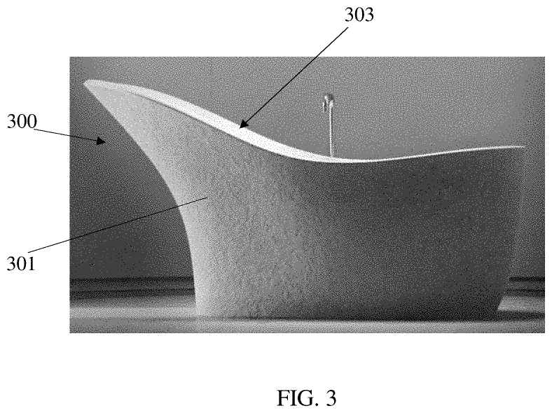

FIG. 3 is a photograph of a colored cement coated bathtub created by another embodiment of the present disclosure. FIG. 3 shows that bathtub 300 has decorative and pigmented (colored) concrete outer surface 301 and solid, but lightweight and pigmented, inner core 303.

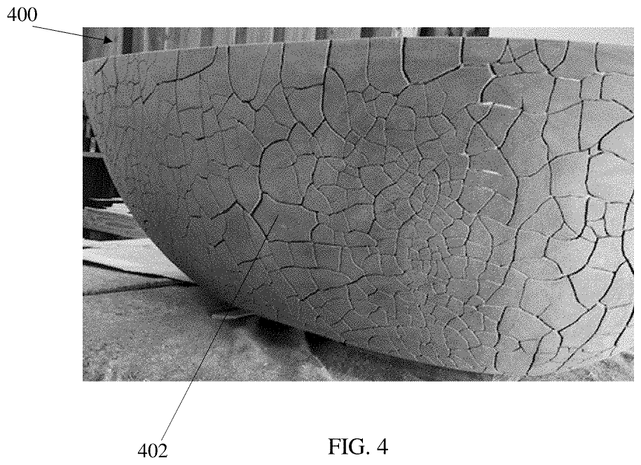

FIG. 4 is a photograph of a cement coated bathtub created by another embodiment of the present disclosure. FIG. 4 shows that bathtub 400 may have a decorative concrete outer surface 402 that may be smooth but have an interesting cracked pattern.

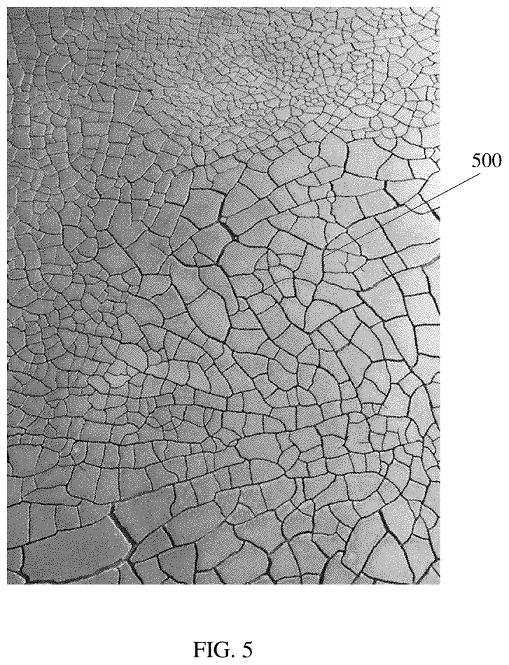

FIG. 5 is a photograph of a cement coated wall panel created by another embodiment of the present disclosure. FIG. 5 shows that the interesting cracked pattern may also be used to make decorative wall panel 500. The panel 500 may be used on other surfaces other than walls.

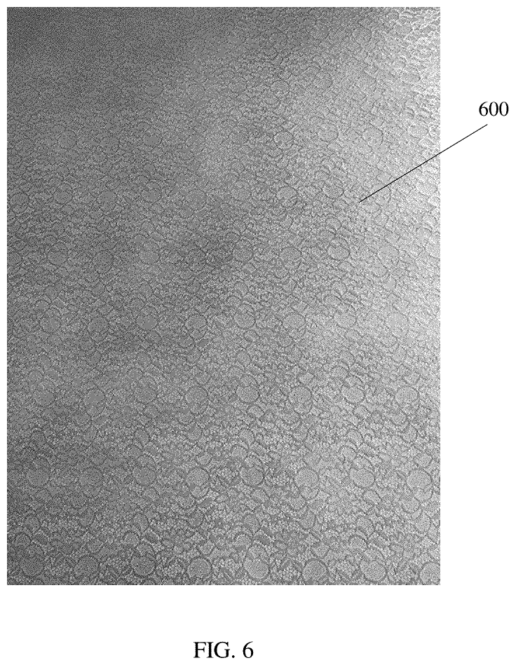

FIG. 6 is a photograph of a cement coated wall panel created by another embodiment of the present disclosure. FIG. 6 shows that the cement panel 600 may have a decorative pattern.

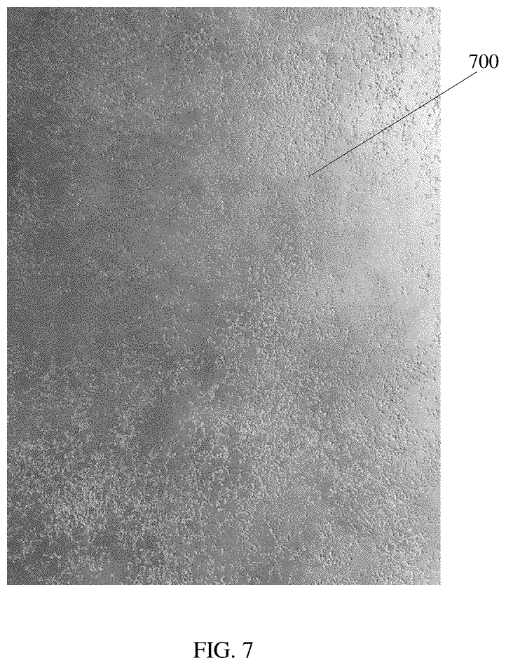

FIG. 7 is a photograph of a cement coated wall panel created by another embodiment of the present disclosure. FIG. 7 shows that the cement panel 700 may have a decorative pattern that makes it look like a natural cement mottled pattern.

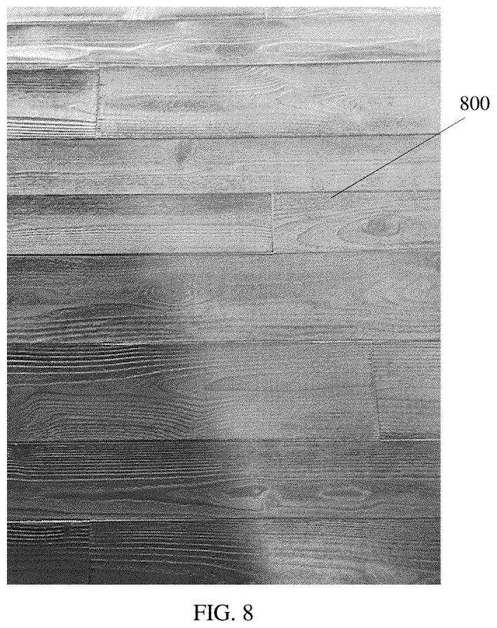

FIG. 8 is a photograph of a cement coated wall panel created by another embodiment of the present disclosure. FIG. 8 shows that the cement panel 800 may have a wood plank pattern.

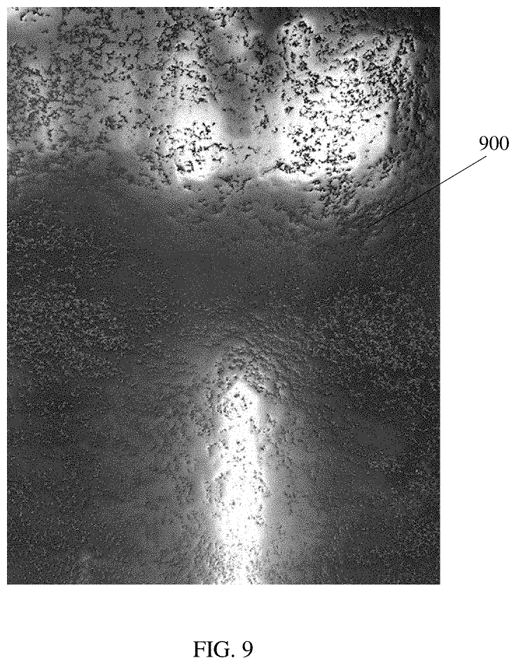

FIG. 9 is a photograph of a metal coated wall panel created by another embodiment of the present disclosure. FIG. 9 shows that the metal panel 900 may have a decorative mottled pattern.

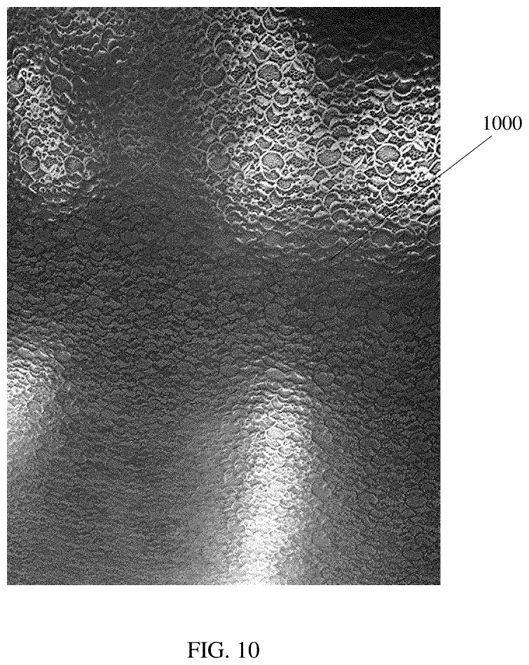

FIG. 10 is a photograph of a metal coated wall panel created by another embodiment of the present disclosure. FIG. 10 shows that the cement panel 1000 may have a decorative pattern.

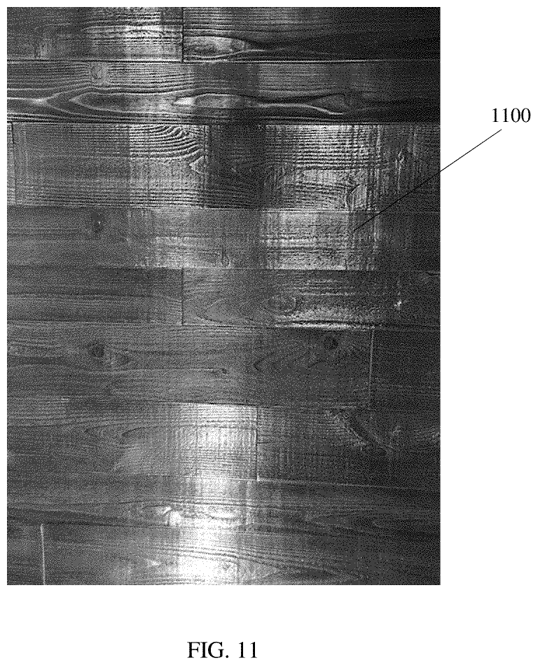

FIG. 11 is a photograph of a metal coated wall panel created by another embodiment of the present disclosure. FIG. 11 shows that the cement panel 1100 may have a wood plank pattern.

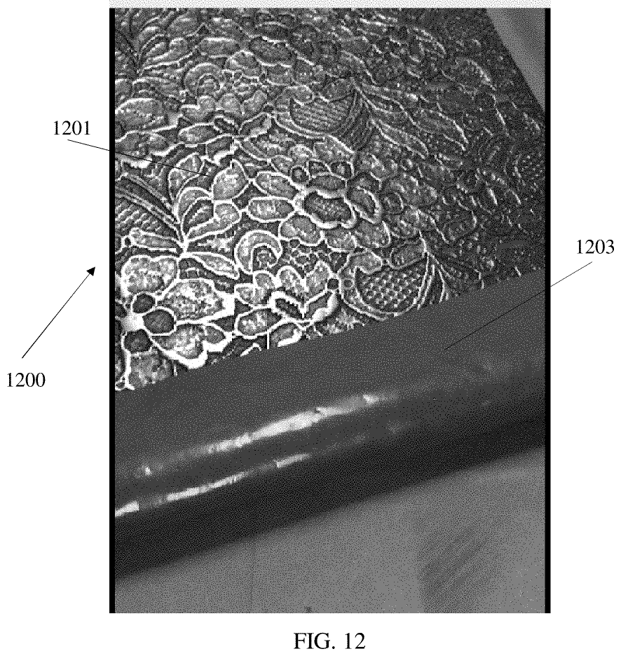

FIG. 12 is a photograph of a flexible urethane metal sheet created by another embodiment of the present disclosure. The flexible urethane metal sheet 1200, also called fabric, may have a polished decorative surface 1201 and urethane backing 1203. The flexible urethane metal sheet 1200 may be flexible and rolled up for easy transport.

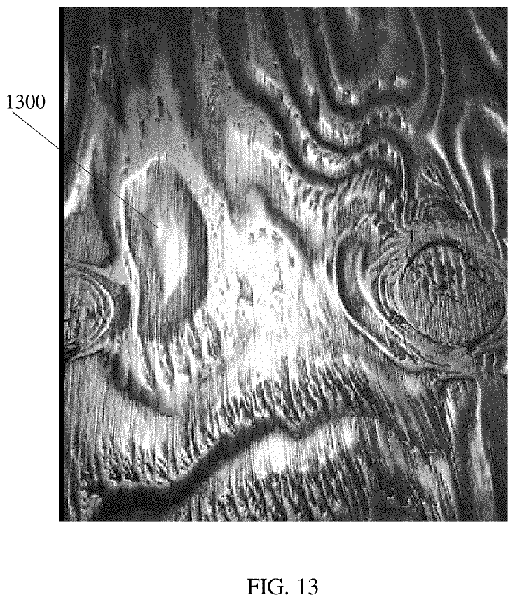

FIG. 13 is a photograph of a flexible urethane metal sheet created by another embodiment of the present disclosure. The flexible urethane metal sheet 1300 may have a polished decorative surface that looks like grained wood.

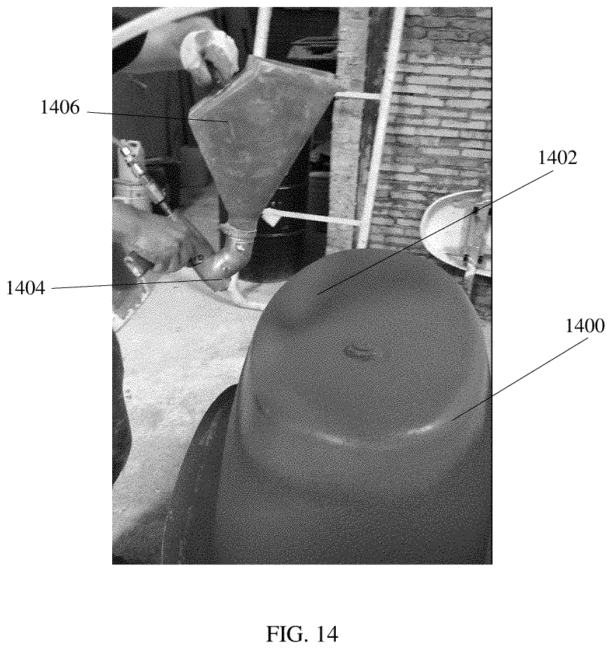

FIG. 14 is a photograph of a cement decorative coating being sprayed onto a mold for creating a bathtub. The bathtub mold 1400 has preferably had a releasing agent applied and is now being coated with a cement or concrete coating 1402 that is being sprayed by spray gun 1404. The decorative cement face coat is poured into hopper 1406 and then sprayed onto the mold 1400.

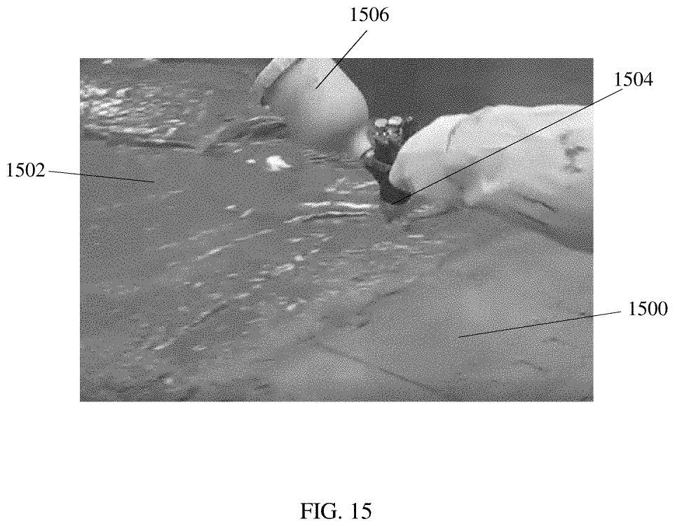

FIG. 15 is a photograph of a metal decorative coating being sprayed onto a mold for creating a panel. FIG. 15 shows that mold 1500 is being sprayed with a metal decorative coating 1502 using spay gun 1504 with hopper 1506, which holds the decorative metal coating mixture.

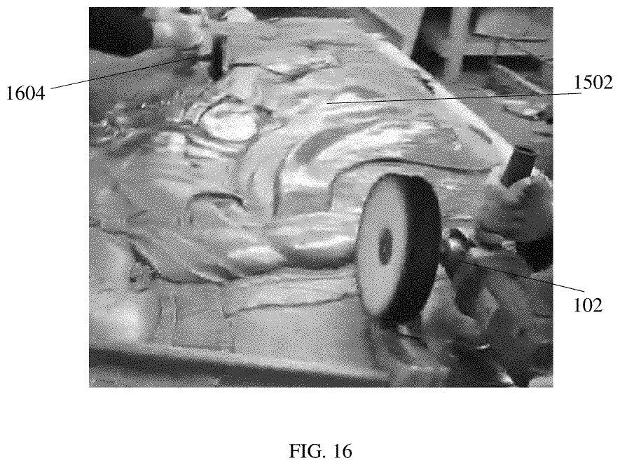

FIG. 16 is a photograph of the metal decoratively coated panel being sprayed polished. FIG. 16 shows that metal decorative coating 1502 from FIG. 15 has hardened and can be polished using polishers 1602, 1604.

Although FIGS. 1-16 show specific decorative surfaces created by a mold, any decoration may be used.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A method of creating a product with a decorative coating comprising:
providing a mold;
mixing a decorative coating material with a substrate material to create a face coat mixture;
spraying said face coat mixture onto said mold;
preparing a backfill mixture, wherein said backfill mixture comprises at least one of a catalyst, a ceramic microsphere filler, and a resin;
pouring said backfill mixture onto said face coat mixture on said mold;
curing said backfill mixture, such that said cured face coat mixture and said cured backfill mixture bind to each other to create a molded product; and
de-molding said molded product.

2. The method of claim 1, further comprising:
applying a releasing agent to said mold; and
curing said sprayed face coat mixture.

3. The method of claim 1, wherein said mold is selected from the group of molds consisting of one or more of: fiberglass; tin cured silicone; and combinations thereof.

4. The method of claim 1, wherein said face coat mixture comprises: a metal powder and a face coat resin.

5. The method of claim 4, wherein said metal powder is at least 99.5% pure grade and −300 to −350 mesh size; and
wherein said face coat resin is selected from the group of resins consisting of one or more of: styrene thinned polyester resin, vinyl ester resin, and combinations thereof.

6. The method of claim 5, wherein said metal powder is selected from the group of metal powders consisting of one or more of: bronze, zinc, tin, brass, aluminum, metal carbides, chromium, cobalt, hafnium, iron, molybdenum, nickel, copper, niobium, platinum, rhenium, silicon, silver, tungsten, tantalum, vanadium, alloys of the same, and combinations thereof.

7. The method of claim 4, wherein said metal powder is, by weight, approximately 2.5 times greater than said face coat resin.

8. The method of claim 4, further comprising:
mixing said face coat mixture with a face coat catalyst before spraying said face coat mixture onto said mold.

9. The method of claim 8, wherein said face coat catalyst is methyl ethyl ketone peroxide and is, by weight, approximately 2% of said face coat resin.

10. The method of claim 4, wherein said backfill mixture comprises: an unsaturated polyester resin and an aluminum powder at approximately 80-120%, by weight, of said unsaturated polyester resin.

11. The method of claim 10, wherein said backfill mixture further comprises a pigment of color at approximately 0.5-3.0%, by weight, of said unsaturated polyester resin.

12. The method of claim 10, further comprising:
mixing said backfill mixture with a backfill mixture catalyst, such that a catalyzed backfill mixture is created.

13. The method of claim 12, wherein said backfill mixture catalyst is methyl ethyl ketone peroxide and is added at approximately 2%, by weight of said backfill mixture.

14. The method of claim 12, further comprising:
degassing said catalyzed backfill mixture in a vacuum chamber before pouring said backfill mixture onto said face coat mixture on said mold.

15. The method of claim 4, further comprising polishing said molded product after it is demolded.

16. The method of claim 1, wherein said face coat mixture comprises: white type 1 Portland cement; quartz; calcium carbonate; powdered polymer; sand; fiberglass mesh; and water.

17. The method of claim 16, wherein said face coat mixture further comprises a pigment of color, which is approximately 0.5-3.0%, by weight, of said face coat mixture;
wherein said white type 1 Portland cement is approximately 20-40%, by weight, of said face coat mixture;
wherein said quartz is approximately 5-25%, by weight, of said face coat mixture;
wherein said calcium carbonate is approximately 10-15%, by weight, of said face coat mixture;
wherein said powdered polymer is approximately 10-15%, by weight, of said face coat mixture;
wherein said sand has a mesh size in the range of 18 to 50 and is approximately 30-35%, by weight, of said face coat mixture; and
wherein said fiberglass mesh is a 3 mm short strand alkali resistant fiberglass mesh and is approximately 0.5-1.0%, by weight, of said face coat mixture.

18. The method of claim 16, further comprising: brushing out said face coat mixture after it is sprayed onto said mold and before it is cured.

19. The method of claim 16, wherein said backfill mixture comprises in approximately equal parts: a urethane and said engineered ceramic microsphere filler.

20. The method of claim 19, further comprising:
degassing said backfill mixture in a vacuum chamber before pouring said backfill mixture onto said face coat mixture on said mold.

21. The method of claim 16, further comprising:
finishing and sealing said molded product after it is de-molded.

22. The method of claim 16, wherein said backfill mixture is a lightweight backing mixture that comprises: said resin and said catalyst.

23. The method of claim 16, wherein said catalyst is methyl ethyl ketone peroxide and is approximately 1.0%-3.0%, by weight, of said resin;
and said resin is selected from the group of resins consisting of one or more of: styrene thinned polyester resin, vinyl ester resin, and combinations thereof.

24. The method of claim 22, further comprising:
spraying said light weight backing mixture onto said cured face coat mixture;
curing said lightweight backing mixture; and
reinforcing an exposed surface of said lightweight backing mixture with a fiberglass spray lay-up process.

25. The method of claim 2, wherein said releasing agent is dimethyl ether.

26. The method of claim 10, wherein said backfill mixture further comprises said engineered ceramic microsphere filler at approximately 80-120%, by weight, of said unsaturated polyester resin
